(19) United States
(12) Patent Application Publication
(10) Pub. No.: US 2006/0039328 A1
(43) Pub. Date: Feb. 23, 2006

(54) Data communication in a wireless communication system using space-time coding

(75) Inventors: Bin Chul Ihm, Anyang-si (KR); Yong Suk Jin, Anyang-si (KR); Kyu Hyuk Chung, Seoul (KR); Min Seok Oh, Seoul (KR)

Correspondence Address: LEE, HONG, DEGERMAN,;KANG & SCHMADEKA, 14th Floor, 801 S. Figueroa Street, Los Angeles, CA, 90017, US

(73) Assignee: LG Electronics Inc.

(21) Appl. No.: 11/205,943

(22) Filed: Aug. 16, 2005

(30) Foreign Application Priority Data
Aug. 17, 2004 (KR) 10-2004-0064549
Aug. 27, 2004 (KR) 10-2004-0067874
Nov. 12, 2004 (KR) 10-2004-0092870

(51) Int. Cl. H04Q 7/00

(52) U.S. Cl. 370/334

(57) ABSTRACT

A method of controlling data communication in a wireless communication system comprises measuring channel quality from data received from a base station having multiple antennas, wherein the base station and a mobile station are in a closed loop space-time coding (STC) communication. The method also comprises determining a first weight matrix based on a number of the multiple antennas of the base station, the weight matrix comprising weight elements. The method also comprises determining a second weight matrix from the first weight matrix in response to a predetermined condition, wherein the second weight matrix is associated with controlling data output using the multiple antennas of the base station for subsequent transmission. The method also comprises providing a number of STC outputs to the base station, wherein the number of STC outputs is associated with the second weight matrix.

### CROSS-REFERENCE TO RELATED APPLICATIONS

Pursuant to 35 U.S.C. § 119(a), this application claims the benefit of earlier filing date and right of priority to Korean Application No. 2004-0064549, filed on Aug. 17, 2004, and Korean Application No. 2004-0092670, filed on Nov. 12, 2004, the contents of which are hereby incorporated by reference herein in their entirety.

### FIELD OF THE INVENTION

The present invention relates generally to a wireless communication system and, more particularly, to data communication using space-time coding.

### BACKGROUND OF THE INVENTION

In an orthogonal frequency division multiplexing/orthogonal frequency division multiplexing access (OFDM/OFDMA) system, a base station for supporting a multi-transmitting antenna receives a weight or channel information from a mobile station for a transmission diversity gain. The base station allocates a channel quality information channel (CQICH) for feedback of a weight or channel information.

FIG. 1 is a diagram illustrating a data communication between a mobile station and a base station in an OFDM/OFDMA system. As such, FIG. 1 shows a method for transmitting information between a mobile station and a base station in an OFDM/OFDMA system using a multi-antenna technique.

Referring to FIG. 1, a base station (BS) uses a multi-transmitting antenna to provide notification of the number of base station antennas and a STC (space-time coding) mode based on the number of base station antennas to a mobile station through a space-time coding zone IE (information element) message. A MIMO DL (multiple-input multiple-output downlink) basic (enhanced) IE message and a CQICH enhanced allocation IE Message (S10) provide notification of a transmission type matrix (S11) and request channel quality information (CQI) (S12, S13).

When the channel quality information is requested by the base station, the mobile station measures a channel quality of a lower link or obtains a weight matrix (W) based the channel quality. A size of the weight matrix W is determined by the number of transmitting antennas of the base station and the number of output signals according to an STC method. The following formula (1) shows one example of the weight matrix W based on four transmitting antennas from the base station and two STC output signals.

$$W = [ \begin{matrix}{w}_{11} & {w}_{12} \\ {w}_{21} & {w}_{22} \\ {w}_{31} & {w}_{32} \\ {w}_{41} & {w}_{42}\end{matrix} ] \qquad ( 1 )$$

The mobile station provides feedback regarding the weight matrix W or the channel quality information obtained by the above formula (1) to the base station through a channel quality information channel (CQICH) (S12).

The base station uses a multi-transmitting antenna to receive a weight from the mobile station by feedback for the enhancement of a received SNR (signal to noise ratio). The base station allocates a CQICH of an upper link to the mobile station for the feedback.

However, in the conventional method, at the time of converting a transmission mode into a transmit array antenna (TxAA) from a space-time transmit diversity (STTD), all the necessary information for a weight matrix has to be informed. Otherwise, the mobile station must report unnecessary index values for a matrix, and the base station must allocate a feedback channel in order to receive index values for the corresponding, which may result in wasted channel allocation.

### SUMMARY OF THE INVENTION

Accordingly, the present invention is directed to data communication using space-time coding that substantially obviates one or more problems due to limitations and disadvantages of the related art.

An object of the present invention is to provide for data communication in a closed loop space-time coding (STC) in which a weight index is allocated to a channel quality information channel (CQICH).

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in one embodiment, a method of controlling data communication in a wireless communication system comprises measuring channel quality from data received from a base station having multiple antennas, wherein the base station and a mobile station are in a closed loop space-time coding (STC) communication. The method also comprises determining a first weight matrix based on a number of the multiple antennas of the base station, the weight matrix comprising weight elements. The method also comprises determining a second weight matrix from the first weight matrix in response to a predetermined condition, wherein the second weight matrix is associated with controlling data output using the multiple antennas of the base station for subsequent transmission. The method also comprises providing a number of STC outputs to the base station, wherein the number of STC outputs is associated with the second weight matrix.

At least part of weight elements of the second weight matrix may be fed back to the base station. Furthermore, at least part of weight elements may be transmitted to the base station through a channel quality information channel. Each weight element may be associated with channel quality of the multiple antennas and is used to control at least transmission power and phase of signal transmitted from the base station. The STC output may correspond to a data stream.

In another embodiment, a method in a network for controlling data communication in a wireless communication system comprises, in a base station having multiple antennas, transmitting data to a mobile station to be used for measuring channel quality, wherein the base station and a mobile station are in a closed loop space-time coding (STC) communication. The mobile station determines a first weight matrix based on a number of the multiple antennas of the base station, the weight matrix comprising weight elements. The mobile station also determines a second weight matrix from the first weight matrix in response to a predetermined condition, wherein the second weight matrix is associated with controlling data output using the multiple antennas of the base station for subsequent transmission. The method also comprises receiving a number of STC outputs from the mobile station, wherein the number of STC outputs is associated with the second weight matrix.

The present invention may preferably use multiple antennas to obtain spatial and temporal diversity. In the present invention, output from space-time coding corresponds to a stream or data stream.

The foregoing and other objects, features, aspects and advantages of the present invention will become more apparent from the following detailed description of the present invention when taken in conjunction with the accompanying drawings. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1 is a diagram illustrating a data communication between a mobile station and a base station in an OFDM/OFDMA system.

FIG. 2 is a diagram illustrating a data communication between a mobile station and a base station in an OFDM/OFDMA system, according to an embodiment of the present invention.

FIG. 3 is a diagram illustrating an exemplary allocation of a weight index to a channel quality information channel (CQICH) by the mobile station based on information set by a base station, according to an embodiment of the present invention.

FIG. 4 is a diagram illustrating an exemplary mapping of a weight matrix to a channel quality information channel (CQICH) by the mobile station based on information set by the base station, according to an embodiment of the present invention.

FIG. 5 is a diagram illustrating a weight mapping when an STC mode is a D-TxAA, according to an embodiment of the present invention.

FIG. 6 is a diagram illustrating a weight mapping when the STC mode is a TxAA, according to an embodiment of the present invention.

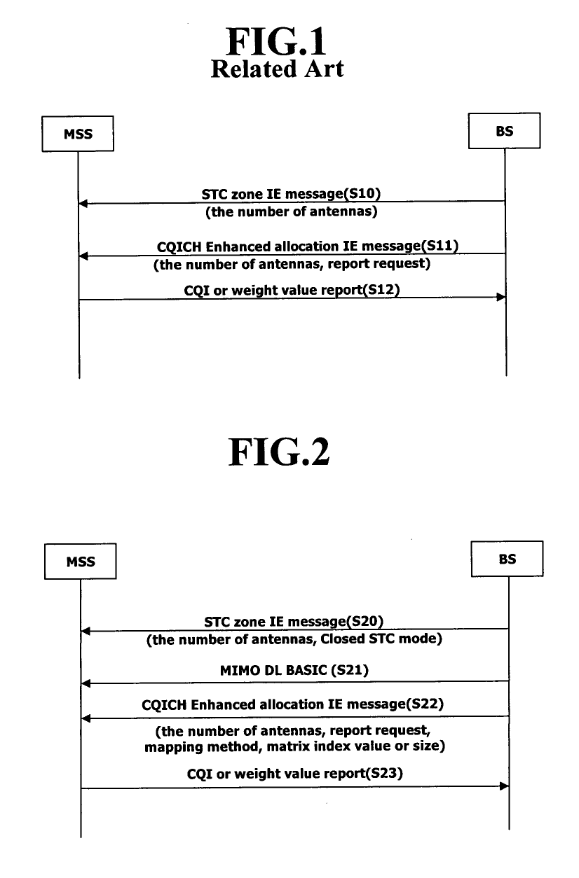

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The present invention may be implemented in an orthogonal frequency division multiplexing (OFDM)/orthogonal frequency division multiplexing access (OFDMA) system. However, the present invention may also be implemented in a wireless communication system operated in accordance with a different standard. Additionally, the mobile station referred to herein may be a user equipment (UE) or other type of mobile station. The present invention may preferably use multiple antennas to obtain spatial and temporal diversity. In the present invention, output from space-time coding corresponds to a data stream.

The present invention provides a method for receiving a weight matrix and channel quality information from a mobile station by a base station having a multi-transmitting antenna for a transmission diversity gain. The base station provides notification of an allocation index of a weight matrix (channel quality information) allocated (mapped) onto a CQICH. The base station also sets a size of a matrix to be reported according to D-TxAA and/or TxAA (transmit array antenna) modes for a closed loop STC (space-time coding) to inform the mobile station.

FIG. 2 is a diagram illustrating a data communication between a mobile station and a base station in an OFDM/OFDMA system, according to an embodiment of the present invention.

Referring to FIG. 2, a base station (BS) uses a multi-transmitting antenna to provide notification of the number of base station antennas, and a closed STC mode based on the number of base station antennas, to the mobile station (MS) through a space-time coding zone IE message (S20). The base station also provides notification of a transmission type MIMO (multiple-input multiple-output) matrix by a closed STC mode through a MIMO DL basic (e.g., enhanced) IE message (S21). As shown in formula (2), below, the base station provides notification of a matrix C that is different from an existing matrix to the base station in order to implement a TxAA mode. The formula (2) shows a matrix C for the TxAA mode in a case where the base station uses two antennas.

$$C = [ \begin{matrix}{S}_{i} \\ {S}_{i}\end{matrix} ] \qquad ( 2 )$$

The base station then provides notification of a mapping method, a matrix index value, and a matrix size through a CQICH enhanced allocation IE message (S22). That is, an allocation index of a matrix element to be mapped into the CQICH, a weight element to be reported, and/or a size of a weight matrix, are set into the CQICH enhanced allocation IE message.

A field for indicating a transmission type MIMO matrix is shown in Table 1, below, and a format of the CQICH enhanced allocation IE message is shown in Table 2, below.

TABLE 1
Matrix indicator field in MIMO DL basic IE

| | | |
|---|---|---|
| Matrix_indicator | 2 | STC=STC mode indicated in |
| | | the latest STC_zone_IE( ). |
| | | If (STC=0b00){ |
| | | 00=Matrix A |
| | | 01=Matrix B |
| | | 10=Matrix C, 11=reserved } |
| | | Else if (STC=0b01) { |
| | | 00=Matrix A, 01=Matrix B |
| | | 10=Matrix C, 11=reserved } |
| | | Else if (STC=0b10) { |
| | | 00=Matrix A, 01=Matrix B |
| | | 10=Matrix C, 11=reserved |

TABLE 2
CQICH Enhanced Allocation IE format

| Syntax | Size (bits) | Notes | |
|---|---|---|---|
| CQICH_Enhanced_Alloc_IE | | | |
| ( ) { | | | |
| Extended DIUC | 4 | | |
| Length | 4 | Length (in bytes) of the following fields. | |
| CQICH ID | Variable | Index to uniquely identify the CQICH resource assigned | |
| | | to the SS. | |
| Period (=p) | 2 | A CQI feedback is transmitted on the CQICH every 2p | |
| | | frames. | |
| Frame offset | 3 | The MS starts reporting at the frame of which the | |
| | | number has the same 3 Isb as the specified frame offset. | |
| | | If the current frame is specified, the MS should start | |
| | | reporting in 8 frames. | |
| Duration (=d) | 3 | A CQI feedback is transmitted on the CQI channels | |
| | | indexed by the CQICH_ID for 10 × 2d frames. | |
| | | If d == 0, the CQICH is deallocated. | |
| | | If d == 111, the SS should report until the BS | |
| | | Commend for the MS to stop. | |
| NT actual BS antennas | 3 | 001 = Reserved | 010 = 2 actual antennas |
| | | 011 = 3 actual antennas | 100 = 4 actual antennas |
| | | 101 = 5 actual antennas | 110 = 6 actual antennas |
| | | 111 = 7 actual antennas | 000 = 8 actual antennas |

| | | |
|---|---|---|
| Feedback type | 4 | 0000 = Open loop precoding. Pilots in burst to be |
| | | precoded with W. MS to rely only on pilots in burst for |
| | | channel estimation |
| | | 0001 = Complex weight of specific element of W |
| | | 0010 = Fast DL measurement |
| | | 0011 = Layer specific channel strengths |
| | | 0100 = MIMO mode and permutation zone feedback |
| | | 0101 = Feedback of subset of antennas to use |
| | | 0110 ˜ 1111 reserved |
| MT STC output antennas | 2 | 00 = the number of columns= 1 |
| | | 01 = the number of columns= 2 |
| | | 10˜11 = reserved |
| TX power | 4 | Available maximum TX power per MS |
| CQICH_Num | 4 | Number of CQICHs assigned to this CQICH_ID is |
| | | (CQICH_Num + 1) |
| For (I=0; I<CQICH_Num; | | |
| i++) { | | |
| Allocation index | 6 | Index to the fast feedback channel region marked by |
| | | UIUC =0 |
| Element index | 5 | If(Feedback type = 0001) |
| | | index of element of weight matrix |
| | | Elseif(Feedback type 0010) |
| | | Index of element of channel quality matrix |
| } | | |
| }else { | | |
| For (whole size of weight | | Dimension of weight matrix is indicated as NT x # of |
| matrix) { | | STC outputs or NT x # of closed-loop STC output |
| Allocation index | 6 | Index to the fast feedback channel region marked by |
| | | UIUC =0 |
| } | | |
| } | | |
| if (Feedback_type != 0011) { | | |
| MIMO permutation feedback | 2 | 00 = No MIMO and permutation mode feedback |
| cycle | | 01 = the MIMO and permutation mode indication shall |
| | | be transmitted on the CQICH indexed by the CQICH_ID |
| | | every 4 frames. The first indication is sent on the 4th |
| | | CQICH frame. |
| | | 10 = the MIMO mode and permutation mode indication |
| | | shall be transmitted on the CQICH indexed by the |
| | | CQICH_ID every 8 frames. The first indication is sent on |
| | | the 8th CQICH frame. |
| | | 11 = the MIMO mode and permutation mode indication |
| | | shall be transmitted on the CQICH indexed by the |
| | | CQICH_ID every 16 frames. The first indication is sent |
| | | on the 16th CQICH frame. |
| } | | |
| Padding | Variable | |
| } | | |

The base station provides notification of an allocation position of a weight onto the CQICH to the mobile station through an element index field of the CQICH enhanced allocation IE message. The base station also provides notification of a size of a weight matrix (e.g., a number of columns in the matrix) through an MT STC output antenna field. For example, ‘00’ indicates that the number of columns in the matrix is 1, and ‘01’ indicates that the number of columns in the matrix is 2.

When the base station requests channel quality information, the mobile station obtains a weight matrix W based on the number of antennas and an STC antenna output. The base station also allocates the weight matrix W onto the CQICH based on the information related to the base station transmitted through the CQICH enhanced allocation IE message. The CQICH enhanced allocation IE message is then fed back to the base station.

The size of the weight matrix W may be determined by information transmitted to the mobile station from the base station. Alternatively, the size of the weight matrix may be determined by the mobile station using methods that involve a measured channel state. When using a method that involves a measured channel state, the mobile station feeds back the number of columns of the weight matrix W to the base station. The base station, in turn, provides notification of a possible transmission power to the mobile station, to enable the mobile station to calculate an optimum W.

The mobile station feeds back the size of the weight matrix to the base station using methods such as those shown in Tables 3 and 4, below. Tables 3 and 4 include feedback payloads with 5 bits and 6 bits, respectively, and provide a database for informing a MIMO method required by the mobile station, a permutation method, and/or a size of a weight matrix. For example, the mobile station may transmit a ‘0b10001’ of 5 bits and a ‘0b110002’ of 6 bits to the base station to provide notification of a closed loop SM (spatial multiplexing), a PUSC/FUSC, and/or 2-STC output method indicating two columns of W to the base station.

TABLE 3
Encoding of payload bits for Fast-feedback slot with 5 bit payload

| Value | Description |
|---|---|
| 0b00000 | STTD and PUSC/FUSC permutation |
| 0b00001 | STTD and adjacent-subcarrier permutation |
| 0b00010 | SM and PUSC/FUSC permutation |
| 0b00011 | SM and adjacent-subcarrier permutation |
| 0b00100 | Hybrid and PUSC/FUSC permutation |
| 0b00101 | Hybrid and adjacent-subcarrier permutation |
| 0b00110 | Beamforming and adjacent-subcarrier permutation |
| 0b10xxx | Closed-loop SM and PUSC/FUSC |
| | permutation |
| 0b11xxx | Closed-loop SM and adjacent-subcarrier permutation |
| 0b1x000 | 1 STC outputs |
| 0b1x001 | 2 STC outputs |
| 0b1x010 | 3 STC outputs |
| 0b1x011 | 4 STC outputs |

TABLE 4
Encoding of payload bits for Fast-feedback slot with 6 bit payload

| Value | Description |
|---|---|
| 0b101000 | STTD and PUSC/FUSC permutation |
| 0b101001 | STTD and adjacent-subcarrier permutation |
| 0b101010 | SM and PUSC/FUSC permutation |
| 0b101011 | SM and adjacent-subcarrier permutation |
| 0b101100 | Hybrid and PUSC/FUSC permutation |
| 0b101101 | Hybrid and adjacent-subcarrier permutation |
| 0b101110 | Beamforming and adjacent-subcarrier permutation |
| 0b110xxx | Closed-loop SM and PUSC/FUSC permutation |
| 0b111xxx | Closed-loop SM and adjacent-subcarrier |
| | permutation |
| 0b11x000 | 1 STC outputs |
| 0b11x001 | 2 STC outputs |
| 0b11x010 | 3 STC outputs |
| 0b11x011 | 4 STC outputs |
| 0b110100-0b111111 | Reserved |

The mobile station may provide notification of the number of STC outputs (e.g., the number of streams or data streams) to the base station using an amount of increase or decrease. For example, when the number of STC outputs changes from 3 to 2, the mobile station feeds back ‘−1 STC output’ to the base station, as shown in Tables 5 and 6, below. Likewise, when the number of STC outputs changes from 3 to 4, the mobile station feeds back ‘+1 STC output’ to the base station, as shown in Tables 5 and 6.

TABLE 5
Encoding of payload bits for Fast-feedback slot with 5 bit payload

| Value | Description |
|---|---|
| 0b00000 | STTD and PUSC/FUSC permutation |
| 0b00001 | STTD and adjacent-subcarrier permutation |
| 0b00010 | SM and PUSC/FUSC permutation |
| 0b00011 | SM and adjacent-subcarrier permutation |
| 0b00100 | Hybrid and PUSC/FUSC permutation |
| 0b00101 | Hybrid and adjacent-subcarrier permutation |
| 0b00110 | Beamforming and adjacent-subcarrier permutation |
| 0b10xxx | Closed-loop SM and PUSC/FUSC |
| | permutation |
| 0b11xxx | Closed-loop SM and adjacent-subcarrier permutation |
| 0b1x000 | +1 STC outputs |
| 0b1x001 | −1 STC outputs |

TABLE 6
Encoding of payload bits for Fast-feedback slot with 6 bit payload

| Value | Description |
|---|---|
| 0b101000 | STTD and PUSC/FUSC permutation |
| 0b101001 | STTD and adjacent-subcarrier permutation |
| 0b101010 | SM and PUSC/FUSC permutation |
| 0b101011 | SM and adjacent-subcarrier permutation |
| 0b101100 | Hybrid and PUSC/FUSC permutation |
| 0b101101 | Hybrid and adjacent-subcarrier permutation |
| 0b101110 | Beamforming and adjacent-subcarrier permutation |
| 0b110xxx | Closed-loop SM and PUSC/FUSC permutation |
| 0b111xxx | Closed-loop SM and adjacent-subcarrier |
| | permutation |
| 0b11x000 | −1 STC outputs |
| 0b11x001 | +1 STC outputs |
| 0b110100-0b111111 | Reserved |

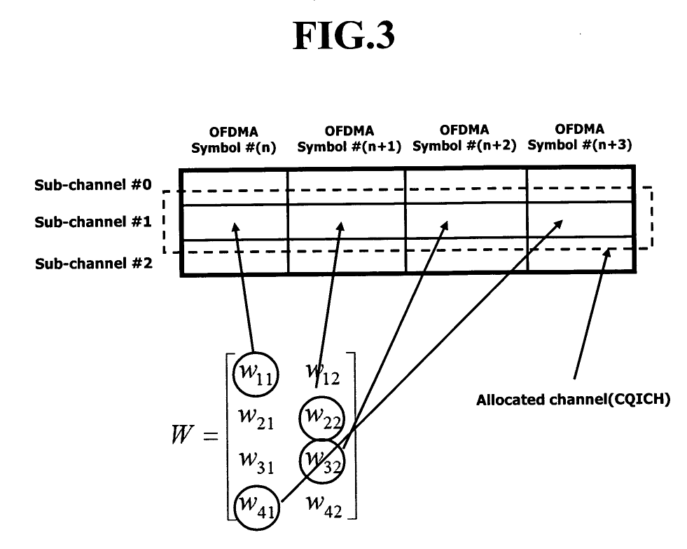

FIG. 3 is a diagram illustrating an exemplary allocation of a weight index to a channel quality information channel (CQICH) by the mobile station based on information set by a base station (e.g., as an element index), according to an embodiment of the present invention.

Referring to FIG. 3, when the base station sets weights (e.g., w11, w22, w32, w41) to be reported through an element index, the mobile station allocates the weights (W11, w22, w32, w41) onto an allocated channel (sub channel #1: CQICH), which are to be fed back to the base station.

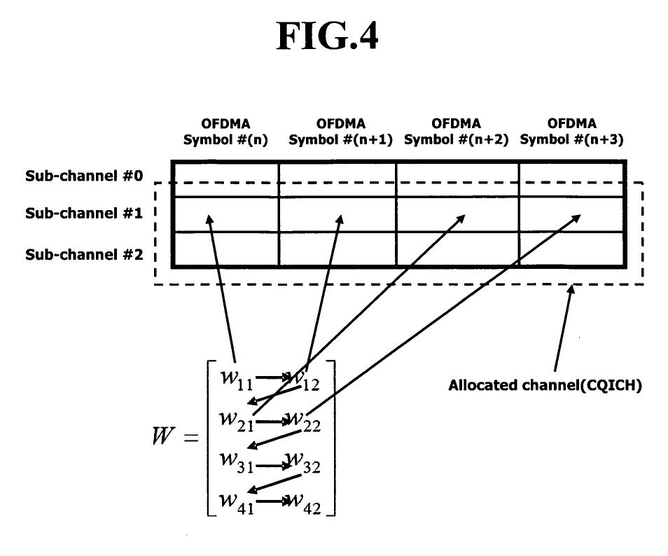

FIG. 4 is a diagram illustrating an exemplary mapping of a weight matrix to a channel quality information channel (CQICH) by the mobile station based on information set by the base station, according to an embodiment of the present invention.

Referring to FIG. 4, the mobile station maps the entire weight matrix W to the allocated channel to provide a report to the base station in the form of a row unit. The mobile station may, in turn, feedback a matrix element required by the base station in a closed loop STC through an STC output antenna field.

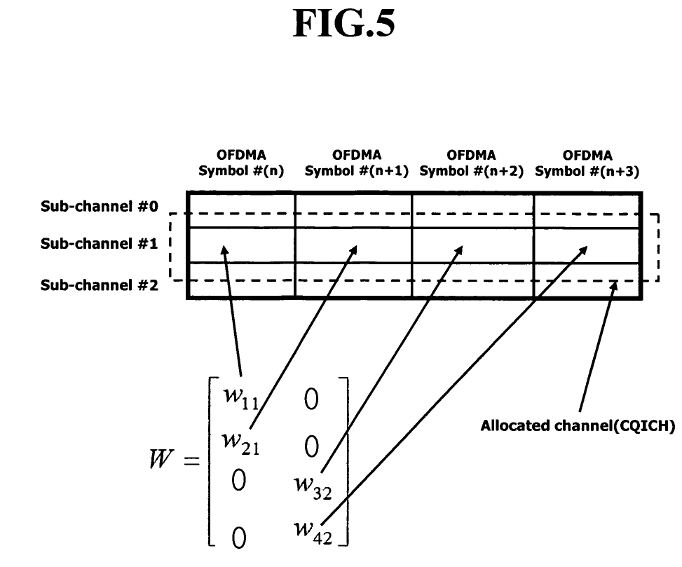

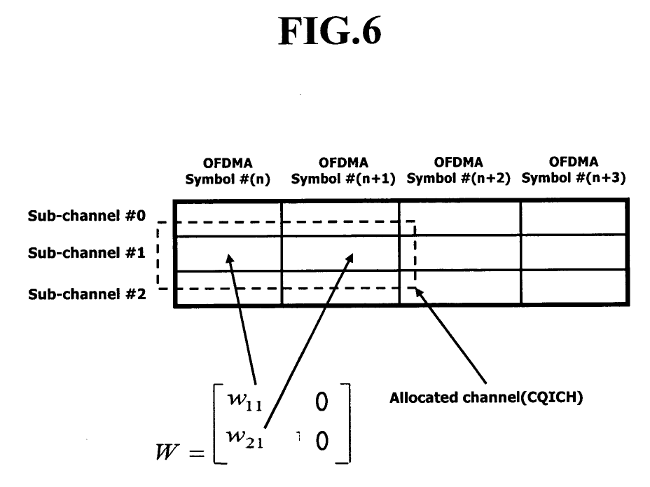

FIG. 5 is a diagram illustrating a weight mapping when an STC mode is a D-TxAA, according to an embodiment of the present invention. FIG. 6 is a diagram illustrating a weight mapping when the STC mode is a TxAA, according to an embodiment of the present invention.

Referring to FIGS. 5 and 6, the base station may provide notification of a method for mapping a weight in a D-TxAA and/or a TxAA mode to the STC output antenna field. For example, at the time of converting a transmission mode into a transmit array antenna (TxAA) from a space-time transmit diversity (STTD), the base station provides necessary information related to a weight matrix to the mobile station. Accordingly, the mobile station may feedback a necessary weight index, without unnecessary element values, through a corresponding channel. When the mobile station informs channel quality information instead of weight information, the mobile station receives a channel quality information matrix through the CQICH. The base station may directly inform a column size of a weight matrix to the mobile station to directly set a size of a weight matrix to be fed back.

In one embodiment, a method of controlling data communication in a wireless communication system comprises measuring channel quality from data received from a base station having multiple antennas, wherein the base station and a mobile station are in a closed loop space-time coding (STC) communication. The method also comprises determining a first weight matrix based on a number of the multiple antennas of the base station, the weight matrix comprising weight elements. The method also comprises determining a second weight matrix from the first weight matrix in response to a predetermined condition, wherein the second weight matrix is associated with controlling data output using the multiple antennas of the base station for subsequent transmission. The method also comprises providing a number of STC outputs to the base station, wherein the number of STC outputs is associated with the second weight matrix.

At least part of weight elements of the second weight matrix may be fed back to the base station. Furthermore, at least part of weight elements may be transmitted to the base station through a channel quality information channel. Each weight element may be associated with channel quality of the multiple antennas and is used to control at least transmission power and phase of signal transmitted from the base station. The STC output may correspond to a data stream.

In another embodiment, a method in a network for controlling data communication in a wireless communication system comprises, in a base station having multiple antennas, transmitting data to a mobile station to be used for measuring channel quality, wherein the base station and a mobile station are in a closed loop space-time coding (STC) communication. The mobile station determines a first weight matrix based on a number of the multiple antennas of the base station, the weight matrix comprising weight elements. The mobile station also determines a second weight matrix from the first weight matrix in response to a predetermined condition, wherein the second weight matrix is associated with controlling data output using the multiple antennas of the base station for subsequent transmission. The method also comprises receiving a number of STC outputs from the mobile station, wherein the number of STC outputs is associated with the second weight matrix.

In the present invention, the base station provides notification of a position of a weight to be transmitted (a mapping method) to the mobile station to enable the base station to receive a required specific weight, without receiving unnecessary weights. Accordingly, problems caused by channels being allocated for unnecessary weights may be remedied. Furthermore, since the base station provides notification of a STC output antenna to the mobile station, it is not necessary to allocate a feedback channel for feedback of unnecessary index values of a weight matrix.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. A method of controlling data communication in a wireless communication system, the method comprising:
measuring channel quality from data received from a base station having multiple antennas, wherein the base station and a mobile station are in a closed loop space-time coding (STC) communication;
determining a first weight matrix based on a number of the multiple antennas of the base station, the weight matrix comprising weight elements;
determining a second weight matrix from the first weight matrix in response to a predetermined condition, wherein the second weight matrix is associated with controlling data output using the multiple antennas of the base station for subsequent transmission; and
providing a number of STC outputs to the base station, wherein the number of STC outputs is associated with the second weight matrix.

2. The method of claim 1, wherein at least part of weight elements of the second weight matrix are fed back to the base station.

3. The method of claim 2, wherein the at least part of weight elements is transmitted to the base station through a channel quality information channel.

4. The method of claim 1, wherein each weight element is associated with channel quality of the multiple antennas and is used to control at least transmission power and phase of signal transmitted from the base station.

5. The method of claim 1, the STC output corresponds to a data stream.

6. A method in a network for controlling data communication in a wireless communication system, the method comprising:
in a base station having multiple antennas, transmitting data to a mobile station to be used for measuring channel quality, wherein the base station and a mobile station are in a closed loop space-time coding (STC) communication;
wherein the mobile station determines a first weight matrix based on a number of the multiple antennas of the base station, the weight matrix comprising weight elements;
wherein the mobile station determines a second weight matrix from the first weight matrix in response to a predetermined condition, wherein the second weight matrix is associated with controlling data output using the multiple antennas of the base station for subsequent transmission; and
receiving a number of STC outputs from the mobile station, wherein the number of STC outputs is associated with the second weight matrix.

7. The method of claim 6, wherein at least part of weight elements of the second weight matrix are fed back to the base station.

8. The method of claim 7, wherein the at least part of weight elements is transmitted to the base station through a channel quality information channel.

9. The method of claim 6, wherein each weight element is associated with channel quality of the multiple antennas and is used to control at least transmission power and phase of signal transmitted from the base station.

10. The method of claim 6, the STC output corresponds to a data stream.

11. A mobile station for controlling data communication in a wireless communication system, the mobile station comprising:
means for measuring channel quality from data received from a base station having multiple antennas, wherein the base station and a mobile station are in a closed loop space-time coding (STC) communication;
means for determining a first weight matrix based on a number of the multiple antennas of the base station, the weight matrix comprising weight elements;
means for determining a second weight matrix from the first weight matrix in response to a predetermined condition, wherein the second weight matrix is associated with controlling data output using the multiple antennas of the base station for subsequent transmission; and
means for providing a number of STC outputs to the base station, wherein the number of STC outputs is associated with the second weight matrix.

12. The mobile station of claim 11, wherein at least part of weight elements of the second weight matrix are fed back to the base station.

13. The mobile station of claim 12, wherein the at least part of weight elements is transmitted to the base station through a channel quality information channel.

14. The mobile station of claim 11, wherein each weight element is associated with channel quality of the multiple antennas and is used to control at least transmission power and phase of signal transmitted from the base station.

15. The mobile station of claim 11, the STC output corresponds to a data stream.

16. A network for controlling data communication in a wireless communication system, the network comprising:
in a base station having multiple antennas, means for transmitting data to a mobile station to be used for measuring channel quality, wherein the base station and a mobile station are in a closed loop space-time coding (STC) communication;
wherein the mobile station determines a first weight matrix based on a number of the multiple antennas of the base station, the weight matrix comprising weight elements;
wherein the mobile station determines a second weight matrix from the first weight matrix in response to a predetermined condition, wherein the second weight matrix is associated with controlling data output using the multiple antennas of the base station for subsequent transmission; and
means for receiving a number of STC outputs from the mobile station, wherein the number of STC outputs is associated with the second weight matrix.

17. The network of claim 16, wherein at least part of weight elements of the second weight matrix are fed back to the base station.

18. The network of claim 17, wherein the at least part of weight elements is transmitted quality information channel.

19. The network of claim 16, wherein each weight element is associated with channel quality of the multiple antennas and is used to control at least transmission power and phase of signal transmitted from the base station.

20. The network of claim 16, the STC output corresponds to a data stream.
